(19) United States
(12) Patent Application Publication
(10) Pub. No.: US 2025/0191079 A1
(43) Pub. Date: Jun. 12, 2025

(54) Localized social network to facilitate in-person interactions

(71) Applicant: Raj Shekhar, East Norwich, NY (US)

(72) Inventor: Raj Shekhar, East Norwich, NY (US)

(73) Assignee: Sandalwood Research LLC, Albany, NY (US)

(21) Appl. No.: 18/977,265

(22) Filed: Dec. 11, 2024

Related U.S. Application Data
(60) Provisional application No. 63/609,078, filed on Dec. 12, 2023.

(51) Int. Cl. G06Q 50/00

(52) U.S. Cl. CPC G06Q 50/01

(57) ABSTRACT

A localized social network consisting of real people is provided, including four different techniques to facilitate people-to-people interactions. The techniques disclosed are related to creations of spontaneous and scheduled interactions, staying in touch with old friends, and keeping people informed of the real events happening in the local communities.

### FIELD

The present application relates generally to techniques to facilitate real-life people-to-people interactions, creating opportunities for such interactions in a spontaneous manner along with scheduled ones, finding missed connections if they are in proximity, and bringing local communities together.

### BACKGROUND

The arrival and evolution of social networks have transformed the way people interact with each other. While this transformation was initially perceived quite positively, the harmful impacts on society have become evident in the last few years.

These social networks are screen-centered, focusing on quantity of content and network size, and are driven by powerful algorithms that utilize extensive amount of user data. Such algorithms are becoming ever more manipulative and have started to successfully affect our real-life behavior. Human beings on average are good at separating truths from lies, a foundational principle in democratic societies, but they are struggling in the presence of these algorithms, largely due to two primary reasons. Firstly, the speed of new content they are bombarded with is simply too much for them to handle. Secondly, these algorithms are creating individualized versions of reality or “echo-chambers,” undermining their collective ability to discern falsehoods. This is leading to erosion of social fabrics and mental health issues, especially among the younger generation, where social media usage appears to have strong correlation with low self-esteem and rising cases of self-harm and suicides, accompanied by a significant decline in real-life social interactions. Moreover, human beings haven't evolved to stay connected with thousands of people, and the constant pursuit of “likes” and approvals is not something their minds can keep up with in the long term.

In summary, people can derive stimulation from mental engagement these social networks provide but need to step out of their headspace and spend time with friends on a regular basis for their own well-being.

### SUMMARY

The invention is defined by the scope of the included independent claims. Taken together, the techniques covered within these claims ensure that only a real person can be part of a social network, an individual's social network is limited to only their real-life friends and their local community, and only real-life activities get facilitated. In the process, these techniques effectively address the inertia that hinders people from spending more time with their friends, specifically by resolving uncertainties about who is nearby, who is available, and who should initiate and organize an activity.

Although not a component of the invention itself, a location-sharing service operating on a mobile computing device is integral to the functionality of the invention. This service involves sharing location details with a similar application on a friend's device to facilitate their integration into the social network. Additionally, it uses the same mechanism to relay the location information of individuals to remote servers. This information is utilized to identify friends within the same geographical vicinity. Importantly, this information does not require precision; therefore, continuous location tracking is unnecessary. Even the approximate location data can be further randomized, adding an additional layer of privacy. Moreover, this setup allows individuals to have complete control over when to update their location information on the server, eliminating the need for any automatic updates of this data.

The invention includes four different techniques for in-person interaction facilitations, as provided through illustrative user interfaces (UIs). The Spontaneous Interactions UI allows an individual to choose a specific activity to enjoy with a selected group of friends within a defined distance. The server then locates friends interested in the same activity and brings them together in a different UI, where they can decide on the meetup location and time. In the Scheduled Interactions UI, an individual can plan an event for a future date, and friends within a certain distance of the event location will receive notifications. The Missed Connections UI lets an individual select friends they've lost touch with; if these friends are nearby, the server connects them in a different UI to arrange a meetup location and time. Lastly, the Community Bulletins UI enables a person in the local community to broadcast event details to people within a specified distance, with community members having control over the distance from which they receive these broadcasts.

This Summary serves to present the key concepts in a simplified manner, with further details provided in the following Detailed Description section. It should be emphasized that this summary is not meant to highlight the essential features of the claimed invention, nor is it intended to be utilized as a tool for determining the scope of the claimed invention.

### BRIEF DESCRIPTION OF THE DRAWINGS

FIG. 1 shows an illustrative interface on an individual's computing device, coupled with a remote computational server depicting the primary components of the present disclosure.

FIG. 2 shows an illustrative interface on an individual's computing device, coupled with a remote computational server depicting the technique to ensure only real people can be on a social network.

FIG. 3 shows an illustrative interface on an individual's computing device, coupled with a remote computational server depicting the technique of creating spontaneous interactions.

FIG. 4 shows an illustrative interface on an individual's computing device, coupled with a remote computational server depicting the technique of creating scheduled interactions with friends within a specified range.

FIG. 5 shows an illustrative interface on an individual's computing device, coupled with a remote computational server depicting the technique of creating missed connections interactions.

FIG. 6 shows an illustrative interface on an individual's computing device, coupled with a remote computational server depicting the technique of creating, utilizing, and maintaining community bulletins.

FIG. 7 depicts the main components of a remote computational server.

FIG. 8 depicts a process flow diagram illustrating search routine on a remote computational server.

### DETAILED DESCRIPTION

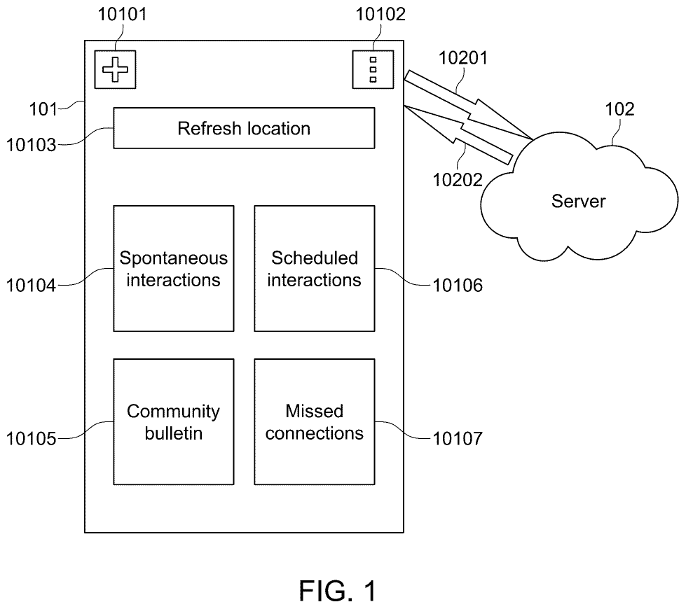

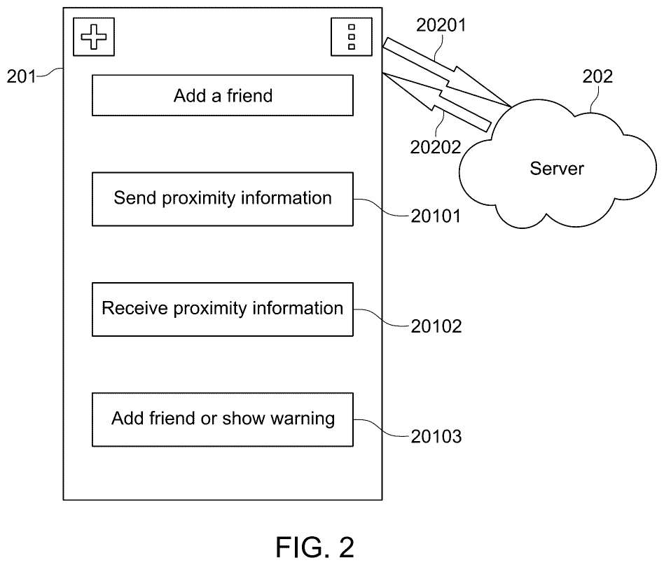

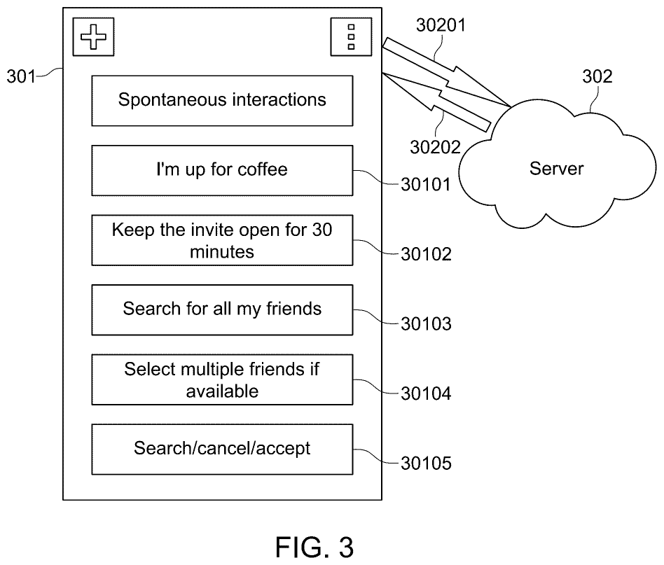

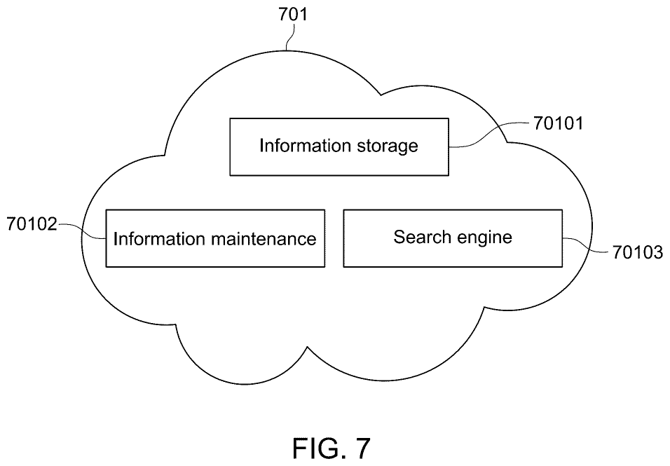

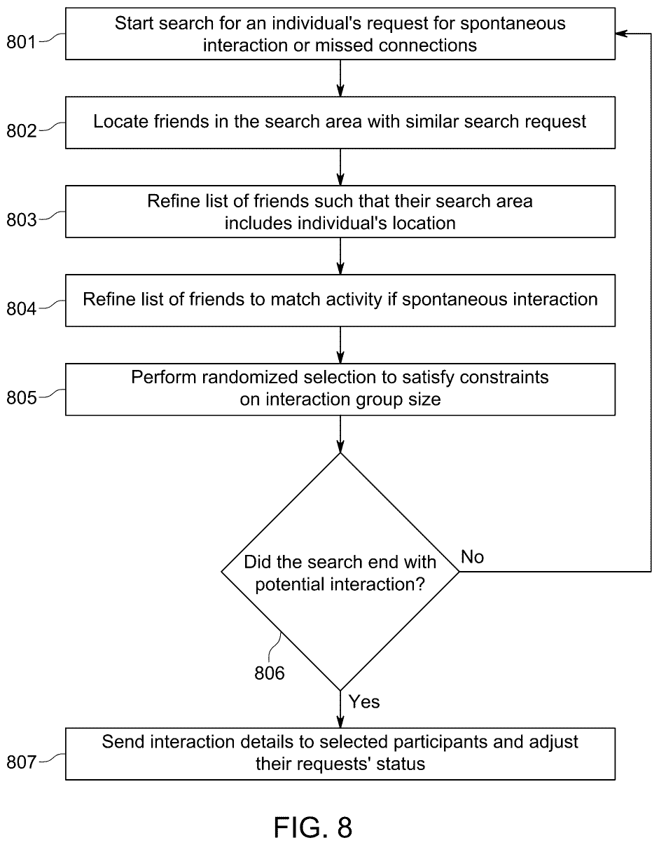

FIG. 1 shows an illustrative computational device 101 and an example schematic of user interface highlighting the main components of this invention. 10101 is an example interface that launches a new user interface, as illustrated in FIG. 2, to onboard a friend onto the social network. 10102 launches a new user interface to control different range settings, to help set specific distance parameters for searching friends and local events. 10103 refreshes the location of the user. As mentioned in the summary section, the location data do not need to be precise, and no location tracking is needed in this invention. The user information, along with any changes to its social network and/or range settings is stored remotely on a computational server, 102. The communications to the server from the individual computational device are depicted by 10201, and equivalent communications from the remote server to individual devices is depicted by 10202. Details of computational work performed on remote servers are included in FIG. 7 and FIG. 8 and have been discussed later in this section. 10104 to 10107 are illustrative interfaces launching individual interfaces for spontaneous interactions, scheduled interactions, missed connections, and local bulletins. The details of these interfaces are illustrated in FIG. 3 to FIG. 6.

FIG. 2 shows an illustrative schematic 201 for onboarding a friend to the social network. 20101 illustrates an interface to send proximity information to a friend's computational device and 20102 illustrates an interface to receive similar proximity information from a friend's computational device. This proximity information can be as simple as a QR code, a bar code, or broadcast over a Bluetooth service within the computational device, just as a few examples. If a friend is within a specified proximity range, they can be added to the social network otherwise a warning is shown highlighting friends can be added only if they are in physical proximity and as a result know each other in real life, as shown in 20103. Any change in the social network is communicated to a remote server, 202, as highlighted in 20201. 20202 highlights additional work done on the server side and communicated to individual computational devices to ensure friendships are mutual, meaning if a friend addition was partial, the server ensures that corresponding change is also reflected in the friend's social network as well. Details of this process along with other computational work performed on remote servers are included in FIG. 7 and are discussed later in this section.

FIG. 3 shows an illustrative schematic 301 for creating spontaneous interactions. 30101 illustrates an interface to select a specific activity an individual may be interested in. Each activity can be one of the choices provided, including being open to anything, or can be customized by the individual and their friends. 30102 illustrates an interface to select how long the individual wants to wait for their friends to be available. This can be a specific duration or can be kept open until cancelled. 30103 illustrates an interface to customize a list of friends the individual wants to interact with for the specified activity. 30104 illustrates an interface to provide options to interact with one or many friends if multiple friends are available. This option list can also be extended to include friends of friends. 30105 highlights an interface to place a request to search for friends, cancel the request, or accept an interaction if friends are available within the specified distance (target area). The search request is communicated to a remote server, 302, as highlighted in 30201. 30202 highlights communication of available friends' information along with conversations on location and time of interaction, that can happen through a separate interface, to individual computational devices. Details of computational work involved in searching for friends are included in FIG. 8 and are discussed later in this section.

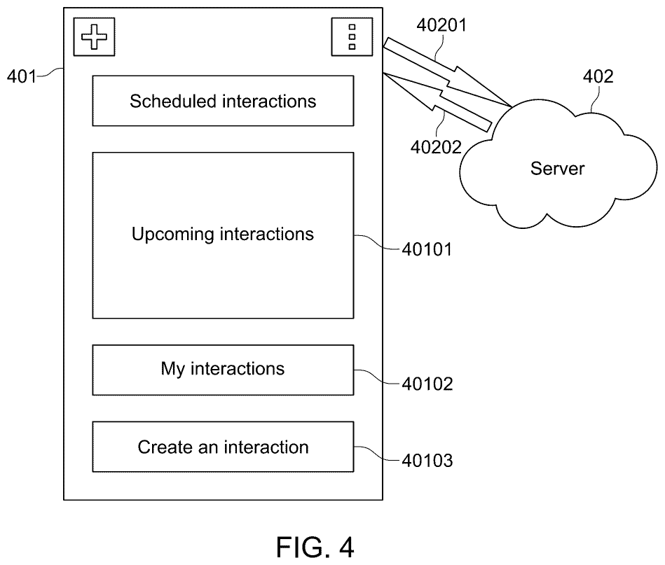

FIG. 4 shows an illustrative schematic 401 for scheduled interactions. 40101 illustrates an interface containing upcoming interactions with friends. These interactions, if created by a friend, will show only if the individual is within specified distance, as configured by the friend, from the interaction location. 40102 illustrates an interface to list all upcoming interactions created by the individual, providing options to edit or delete any such interactions. 40103 illustrates an interface to create an event, where an individual can set the details of interactions along with location, time, invite list, and distance range for the invite if chosen to do so. Any updates to the upcoming interactions are communicated to a remote server, 402, as highlighted in 40201. 40202 highlights communication of such updates to individual computational devices.

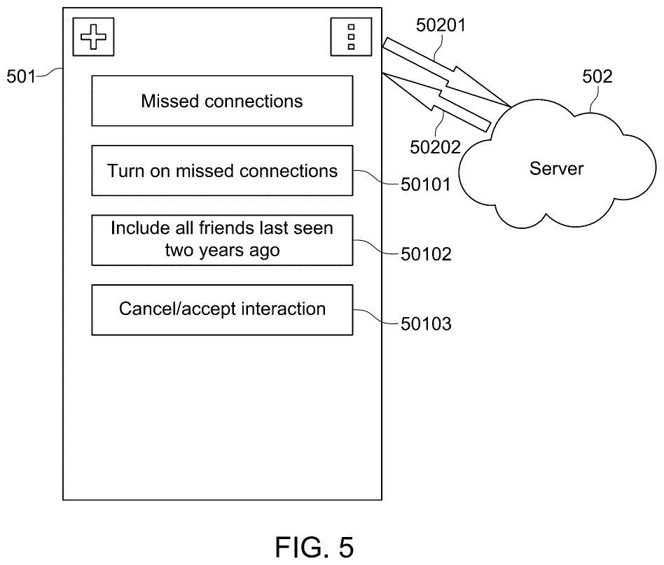

FIG. 5 shows an illustrative schematic 501 for creating missed connections interactions. 50101 illustrates an interface to turn-on or turn-off the search for any missed connections in the specified distance range. 50102 illustrates an interface to customize the list of friends the individual treats as missed connections. This includes a time specification to include selected friends if last seen beyond the selected period. 50103 highlights an interface to cancel or accept interaction if missed connections are available within the specified distance. The search request is communicated to a remote server, 502, as highlighted in 50201. 50202 highlights communication of available missed connections information along with conversations on location and time of interaction, that can happen through a separate interface, to individual's computational devices. Details of computational work involved in searching for missed connections are included in FIG. 8 and has been discussed later in this section.

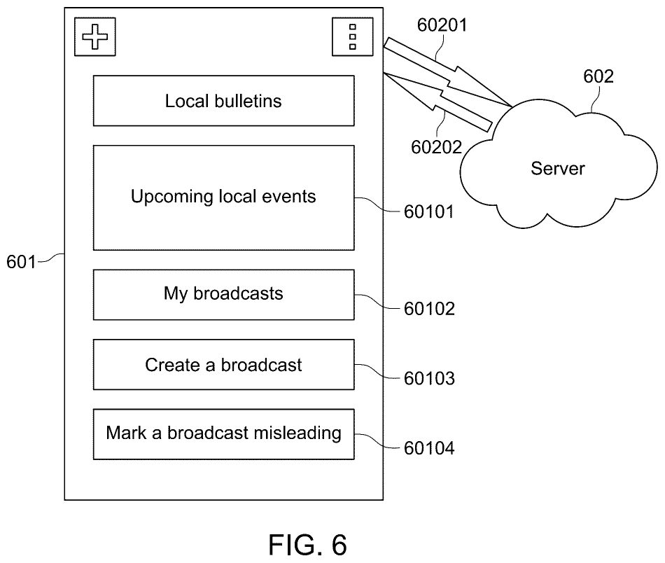

FIG. 6 shows an illustrative schematic 601 for local bulletins. 60101 illustrates an interface containing upcoming local events with details on location and start plus end time. These events will show only if the individual is within a specific distance from the location as set for each event, along with individual's own restriction on distance range for viewable local events. 60102 illustrates an interface to list all upcoming events created by the individual, providing options to edit or delete any such events. 60103 illustrates an interface to create an event, where an individual can set the details including location, time, invite list, and distance range for event visibility. Creation of such events is allowed only when in the physical proximity of the event location. 60104 illustrates an interface to mark any local event broadcast misleading, providing a mechanism to maintain the quality of local bulletins. Any updates to the upcoming events are communicated to a remote server, 602, as highlighted in 60201. 60202 highlights communication of updates to local events to individual computational devices.

FIG. 7 shows an illustrative schematic 701 containing the main components of a remote server. 70101 represents the infrastructure around information storage. The types of data can include, for example, individuals' profiles and preferences information along with their social network details, details of scheduled interactions, local events broadcasted, and individuals' status information containing location and details of their spontaneous interactions and missed connections settings and corresponding expiration times. 70102 represents a set of data maintenance routines to be executed on a regular basis. This maintains consistency of individuals' information, especially the social network details. It ensures that friendships are mutual across social networks. Past interactions and local events are archived, or simply removed, and inactive users are removed to keep the social networks updated. 70103 represents the search engine routine central to finding available friends for spontaneous interactions as well as for missed connections. Details of this routine are included in FIG. 8 and are discussed below.

FIG. 8 illustrates an example flow diagram for an embodiment of the search engine routine 801 on a remote computational server. 801 highlights that this routine needs to be executed in a loop looking for individual requests for spontaneous interactions or missed connections. For any individual request, the routine locates friends in the target area with similar requests as illustrated in 802. 803 ensures that the individual is located within their friends' target area as well. 804 illustrates special treatment for spontaneous interactions and will be skipped for missed connections. This ensures that friends' activity matches with that of the individual. 805 ensures that interaction size is respected if more than one friend is selected after 804. For example, if the individual has requested an interaction with only one friend, or the request type is missed connections, a friend is selected randomly to be included in the proposed interaction. 806 checks if the potential interaction has been created or not. If a viable interaction has been created, 807 notifies the participants and updates their requests' status.

Aspects of this disclosure are described through illustrative interfaces, flowchart illustrations, and block diagrams of methods in accordance with various embodiments. It should be noted that these interfaces, flowcharts, and block diagrams can be executed via computer-readable program instructions. Additionally, it is acknowledged that in certain implementations, the functionality attributed to the interfaces, methods, and routines discussed may be distributed differently, such as being divided among more interfaces with varying layouts or combined into fewer interfaces. Furthermore, the functionality of the depicted interfaces, methods, and routines may vary, offering either more or less functionality than described, or differing in the extent of functionality provided. The sequence and manner of operations, whether depicted as serial or parallel, synchronous, or asynchronous, can also vary in other implementations. The order and method of execution may differ from those illustrated. Data structures referenced in this disclosure may be organized differently in alternative implementations. This includes the possibility of a single data structure being divided into multiple structures, or multiple structures being consolidated into one. In some cases, these data structures may store varying quantities of information, which could involve changes in the amount or types of information stored.

From the above discussion, it is clear that while specific embodiments have been detailed for illustrative purposes, a range of modifications can be made without departing from the essence and ambit of the invention. Therefore, the scope of the invention is defined not by the detailed description, but by the accompanying claims and the elements specified therein. Additionally, although certain aspects of the invention may be expressed in specific claim forms at times, the inventor envisages the various aspects of the invention in any possible claim form.

1. One or more computer-readable memories storing instructions which, when executed by one or more processors disposed in one or more computational devices with or without a display that supports a user interface for interacting with the device, and one or more remote computational resources, implement a method creating localized social network consisting of only real people. The method comprising the steps of:
using a computational device, allow a computational device user to place registration request with one or many of identifiers, these identifiers may include but not limited to name, email address, and phone number;
using one or more remote computational resources, process registration request, providing them unique identity;
using computational devices along with one or more remote computational resources maintain social network of a registered user;
using a computational device, allow a registered user to place a request to add another registered user as a friend; and
using computational devices and location of these computational devices, establish physical proximity while processing friend addition requests.

2. The computer-implemented method of claim 1, wherein a registered user's social network is exclusive and private, inaccessible to other registered users.

3. The computer-implemented method of claim 1, wherein a registered user can add another registered user as a friend if they are within 300 feet of each other.

4. The computer-implemented method of claim 1, wherein a process continuously updates individual social networks to reflect changes in the registered user base and modifications to each user's network.

5. The computer-implemented method of claim 4, wherein, if a user's registration is canceled, the user is removed from the social networks of all their existing friends.

6. The computer-implemented method of claim 4, wherein, if a registered user is part of another user's social network, the other user is also part of the first user's social network.

7. One or more computer-readable memories storing instructions which, when executed by one or more processors disposed in one or more computational devices with or without a display that supports a user interface for interacting with a device, and one or more remote computational resources, implement a method to create spontaneous interactions. The method comprising the steps of:
A registered user updates their location if moved away from their last updated location through an UI on a computational device;
the user chooses a specific activity to enjoy with a selected group of friends within a specified distance through an UI on a computational device;
the user chooses whether to interact with one friend or multiple friends;
remote computational resources run a process to locate friends nearby, are interested in the same activity, and sends alerts or notifications to users on their computational devices; and
users decide on the meetup location and time through an UI on their computational devices.

8. The computer-implemented method of claim 7, wherein a registered user's location is randomized by up to one mile before being transmitted to remote computational resources.

9. The computer-implemented method of claim 7, wherein a registered user configures a list of friends for interaction.

10. The computer-implemented method of claim 7, wherein a registered user selects an activity from a standard set of default options or from custom activities previously agreed upon with their friends.

11. The computer-implemented method of claim 7, wherein a registered user configures the search area for friends to a radius of up to ten miles.

12. The computer-implemented method of claim 7, wherein a registered user can keep the search open for a duration ranging from fifteen minutes to one hour, or until they choose to cancel it.

13. The computer-implemented method of claim 7, wherein a registered user is not required to share their location with their friends.

14. The computer-implemented method of claim 7, wherein a registered user is not required to share their activity of interest with their friends when submitting a search request.

15. One or more computer-readable memories storing instructions which, when executed by one or more processors disposed in one or more computational devices with or without a display that supports a user interface for interacting with a device, and one or more remote computational resources, implement a method to create scheduled interactions bringing friends together in a local area. The method comprising the steps of:
a registered user plans an event for a future date, selects friends, and sets invitation distance relative to the event location through an UI on a computational device; and
remote computational resources run a process to send the event invite to selected friends if within the specified distance from the event location.

16. The computer-implemented method of claim 15, wherein a registered user can configure event details, including the event name, description, start time, duration, and location name.

17. The computer-implemented method of claim 15, wherein a registered user can configure the event location precisely by tapping on a map to provide latitude and longitude coordinates.

18. The computer-implemented method of claim 15, wherein a registered user can configure the invitation list for the event by selecting one or more friends.

19. The computer-implemented method of claim 15, wherein a registered user sets the invitation radius to up to ten miles.

20. The computer-implemented method of claim 17, wherein remote computational resources identify friends within the invitation radius and send invitations to their computational devices.

21. The computer-implemented method of claim 20, wherein remote computational resources send additional invitations to friends who update their location before the event start time and come within the invitation radius.

22. One or more computer-readable memories storing instructions which, when executed by one or more processors disposed in one or more computational devices with or without a display that supports a user interface for interacting with a device, and one or more remote computational resources, implement a method to keep old friends connected. The method comprising the steps of:
a registered user updates their location if moved away from their last updated location through an UI on a computational device;
the user selects friends they've lost touch with, along with specifying search distance through an UI on a computational device;
remote computational resources run a process to locate friends nearby, are looking for missed connections as well, and sends alerts or notifications to users on their computational devices; and
users decide on the meetup location and time through an UI on their computational devices.

23. The computer-implemented method of claim 22, wherein a registered user's location is randomized by up to one mile before being transmitted to remote computational resources.

24. The computer-implemented method of claim 22, wherein a registered user configures a list of friends for interaction.

25. The computer-implemented method of claim 24, wherein a registered user initializes a list of friends based on configurable criteria, such as those not seen within the past two years.

26. The computer-implemented method of claim 22, wherein a registered user configures the search area for friends to a radius of up to ten miles.

27. The computer-implemented method of claim 22, wherein a registered user can start or stop the search at any time.

28. The computer-implemented method of claim 22, wherein a registered user is not required to share their location with their friends.

29. One or more computer-readable memories storing instructions which, when executed by one or more processors disposed in one or more computational devices with or without a display that supports a user interface for interacting with a device, and one or more remote computational resources, implement a method to keep local communities engaged with real life interactions. The method comprising the steps of:
a registered user places request to broadcast an event's details within a specified distance through an UI on a computational device;
using the location of the computational device, establish physical proximity from the event location to process event broadcast requests;
remote computational resources run a process to filter events for users based on their preferred broadcast receive distance and each event's broadcast range, and sends alerts or notifications to users on their computational devices; and
users receive event broadcasts through an UI on their computational devices.

30. The computer-implemented method of claim 29, wherein a registered user can configure event details, including the event name, description, start time, duration, and location name.

31. The computer-implemented method of claim 29, wherein a registered user can configure the event location precisely by tapping on a map to provide latitude and longitude coordinates.

32. The computer-implemented method of claim 29, wherein a registered user sets the broadcast radius to up to ten miles.

33. The computer-implemented method of claim 29, wherein a registered user can broadcast an event at the event location only if they are within 300 feet of the location.

34. The computer-implemented method of claim 29, wherein a registered user is limited to broadcasting no more than six events per day.

35. The computer-implemented method of claim 29, wherein the details of a broadcast event are transmitted to remote computational devices.

36. The computer-implemented method of claim 29, wherein remote computational resources identify events near a registered user and transmit them to their computational devices.

37. The computer-implemented method of claim 29, wherein a registered user can mark an event broadcast misleading provided they have accessed the event details on their computational devices.
